(19) United States
(12) Patent Application Publication
(10) Pub. No.: US 2012/0019616 A1
(43) Pub. Date: Jan. 26, 2012

(54) 3D image capturing and playing device

(76) Inventor: Wei Hong CHEN, Hsinchu City (TW)

(21) Appl. No.: 12/804,686

(22) Filed: Jul. 26, 2010

(51) Int. Cl. H04N 13/00

(52) U.S. Cl. 348/43; 348/E13.003; 348/E13.035; 348/E13.074

(57) ABSTRACT

A 3D image capturing and playing device includes: a 3D image capturing module, an audio capturing module, a control unit, and a video playing module. The 3D image capturing module, which includes a first image capturer, a second image capturer, and a frame composer, captures a 3D image of an external object and converts the 3D image into a digital image signal. The video playing module includes a display converter, a DLP projection engine, a liquid crystal display (LCD), and a synchronous signal emitter. The 3D image capturing and playing device not only has the two horizontally aligned image capturers for capturing the 3D image, but also is built-in with the DLP projection engine and the LCD for projecting or directly displaying the 3D image. Hence, the device is self-contained and easy to operate, thereby meeting the consumer need of taking, playing, and projecting 3D images.

### BACKGROUND OF INVENTION

1. Field of the Invention

The present invention relates to 3D image capturing and playing devices and, more particularly, to a self-contained 3D image capturing and playing device which has two horizontally aligned image capturers for capturing a 3D image and which is built-in with a DLP projection engine and a liquid crystal display (LCD) for projecting or directly displaying the 3D image as desired.

2. Description of the Prior Art

Because of the technological advancements and people's needs for appealing and dazzling visual effects, 3D image-related technology has become increasingly popular.

Typically, a conventional camera or camcorder for taking 3D pictures or 3D videos works by capturing two 2D images, using two photographic devices that simulate the left and right human eyes, respectively, and then processing the two 2D images in such a manner that they can be alternately displayed. Afterward, a projector projects the two alternately displayable 2D images onto an external screen. Meanwhile, a synchronous signal emitter emits a synchronous signal corresponding to the frequency of alternation of the two 2D images, and in response to the synchronous signal, a pair of 3D eyeglasses switch the two 2D images in the left- and right-eye views to ensure that the wearer of the 3D eyeglasses sees one of the two 2D images in one eye and the other of the two 2D images in the other eye, thus enabling the wearer to see a 3D image. However, the prior art has its drawbacks. In particular, the conventional 3D camera or camcorder and the conventional projector for playing 3D pictures or 3D images are independent of each other, and hence a consumer has to buy two compatible devices. Also, the conventional 3D camera or camcorder and the conventional projector lack ease of use and appeal for the general public.

### BRIEF SUMMARY OF THE INVENTION

A primary objective of the present invention is to provide a self-contained and easy-to-operate 3D image capturing and playing device which has two horizontally aligned image capturers for capturing a 3D image and which is built-in with a DLP projection engine and a liquid crystal display (LCD) so that the 3D image can be either projected outward or directly displayed on the LCD, thereby meeting the consumer need of taking, playing, and projecting 3D images.

In order to achieve aforementioned objective, the present invention discloses a 3D image capturing and playing device, comprising:

a 3D image capturing module for capturing an image from an outside and converting the image into a digital image signal;

an audio capturing module for capturing a sound from the outside and converting the sound into a digital audio signal;

a control unit coupled to the 3D image capturing module and the audio capturing module and configured for control thereof and for receiving and combining the digital image signal and the digital audio signal into computer-readable digital video data;

a memory module coupled to the control unit and controlled thereby to store the digital video data or allow the digital video data stored in advance to be read;

a video playing module coupled to the control unit and controlled thereby to play the digital video data externally, wherein the video playing module comprises a display converter, a DLP projection engine, a liquid crystal display (LCD), and a synchronous signal emitter; and

a power module for supplying power to the 3D image capturing and playing device,

wherein the display converter receives an image playing control signal and the digital video data from the control unit and, according to the image playing control signal transmitted from the control unit, determines whether to convert the digital video data into a 3D image playing signal or a 2D image playing signal and whether to send the 3D image playing signal or the 2D image playing signal to the DLP projection engine, the LCD, or both the DLP projection engine and the LCD for playing;

wherein the synchronous signal emitter emits a synchronous control signal corresponding to the 3D image playing signal while the DLP projection engine or the LCD is playing the 3D image playing signal.

In a preferred embodiment, the 3D image capturing module comprises:

a first image capturer for capturing a first image from the outside and generating a plurality of first image frame signals accordingly;

a second image capturer for capturing a second image from the outside and generating a plurality of second image frame signals accordingly, the second image capturer being horizontally spaced apart from the first image capturer by a predetermined distance; and

a frame composer coupled between the first image capturer, the second image capturer, and the control unit and configured for receiving the first image frame signals and/or the second image frame signals and generating the digital image signal accordingly,

wherein the 3D image capturing module is controlled by the control unit to operate in one of a 3D image capturing mode and a 2D image capturing mode;

wherein, with the 3D image capturing module operating in the 3D image capturing mode, the frame composer receives the first and second image frame signals from the first and second image capturers, respectively, and composes the digital image signal in such a manner that the first image frame signals alternate with the second image frame signals;

wherein, with the 3D image capturing module operating in the 2D image capturing mode, the frame composer only receives the first image frame signals from the first image capturer and composes the digital image signal accordingly.

In a preferred embodiment, with the 3D image capturing module operating in the 2D image capturing mode, the first image capturer generates the first image frame signals at a first frequency, and the frame composer composes the digital image signal at the first frequency.

In a preferred embodiment, with the 3D image capturing module operating in the 3D image capturing mode, the first image capturer and the second image capturer generate the first image frame signals and the second image frame signals at a second frequency, respectively, the second frequency being half of the first frequency, and the frame composer composes the digital image signal at the first frequency.

In a preferred embodiment, with the 3D image capturing module operating in the 3D image capturing mode, the first image capturer and the second image capturer generate the first image frame signals and the second image frame signals at the first frequency, respectively, and the frame composer captures the first image frame signals and the second image frame signals at the second frequency, respectively, and composes the digital image signal at the first frequency, the second frequency being half of the first frequency.

In a preferred embodiment, with the 3D image capturing module operating in the 3D image capturing mode, the first image capturer and the second image capturer generate the first image frame signals and the second image frame signals at the first frequency, respectively, and the frame composer captures the first image frame signals and the second image frame signals at the first frequency, respectively, and composes the digital image signal at a third frequency, the third frequency being two times the first frequency.

In a preferred embodiment, the 3D image capturing and playing device further comprises an audio playing unit, wherein the audio capturing module comprises a microphone (Mic) for capturing the sound from the outside, and an audio codec coupled between the Mic and the control unit, the audio codec not only converting the sound captured by the Mic into the digital audio signal but also converting the digital audio signal transmitted from the control unit into another sound to be played by the audio playing unit externally.

In a preferred embodiment, the LCD is a parallax barrier screen switchable between a 3D display mode and a 2D display mode;

wherein, with the digital video data being generated in the 3D image capturing mode and with the display converter determining to convert the digital video data into the 3D image playing signal according to the image playing control signal, the display converter not only sends, at a multiplied speed and by alternation, the first and second image frame signals to the DLP projection engine and/or the LCD in the 3D display mode, but also controllably instructs the synchronous signal emitter to emit the synchronous control signal synchronized with the alternating first and second image frame signals, the synchronous control signal being received by externally provided 3D shutter glasses such that the 3D shutter glasses switch left- and right-eye views according to the synchronous control signal received and thus effectuate 3D imaging;

wherein, with the digital video data being generated in the 3D image capturing mode and with the display converter determining to convert the digital video data into the 2D image playing signal according to the image playing control signal, the display converter only sends the first image frame signals to the DLP projection engine and/or the LCD in the 2D display mode, and the synchronous signal emitter is not operating;

wherein, with the digital video data being generated in the 2D image capturing mode, the display converter only converts the digital video data into the 2D image playing signal to be played by the DLP projection engine and/or the LCD in the 2D display mode, and the synchronous signal emitter is not operating.

In a preferred embodiment, the 3D image capturing and playing device further comprises:

an operating interface coupled to the control unit and comprising a plurality of control keys by which the 3D image capturing and playing device is operated and controlled; and

a signal I/O module coupled to the control unit and comprising a digital data transmission port, an audio output terminal, and an image output terminal respectively connectable to an external electronic device to thereby transmit the digital video data, the digital audio signal, and the 3D or 2D image playing signal.

In a preferred embodiment, the digital data transmission port conforms to one of a USB standard, a mini-USB standard, and an IEEE 1394 standard, and the memory module comprises at least one of an external memory unit, a built-in memory unit, and a dynamic random access memory (DRAM), the external memory unit comprising a card reader for receiving and accessing data stored in an externally provided memory card, and the built-in memory unit comprising at least one of a hard disk drive and a flash memory.

### BRIEF DESCRIPTION OF THE DRAWINGS

The invention as well as a preferred mode of use, further objectives and advantages thereof will be best understood by reference to the following detailed description of an illustrative embodiment when read in conjunction with the accompanying drawings, wherein:

FIG. 1 is a schematic view of a 3D image capturing and playing device in a preferred embodiment of the present invention; and

FIG. 2 is a block diagram of the circuit of the 3D image capturing and playing device in the preferred embodiment of the present invention.

### DETAILED DESCRIPTION OF THE PREFERRED EMBODIMENT

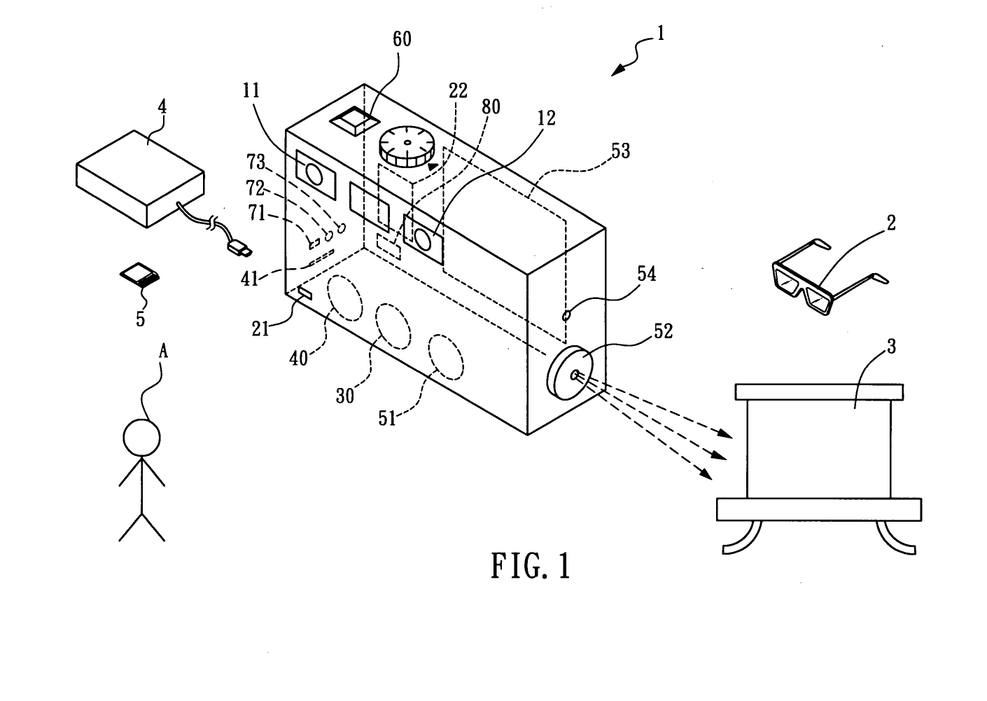

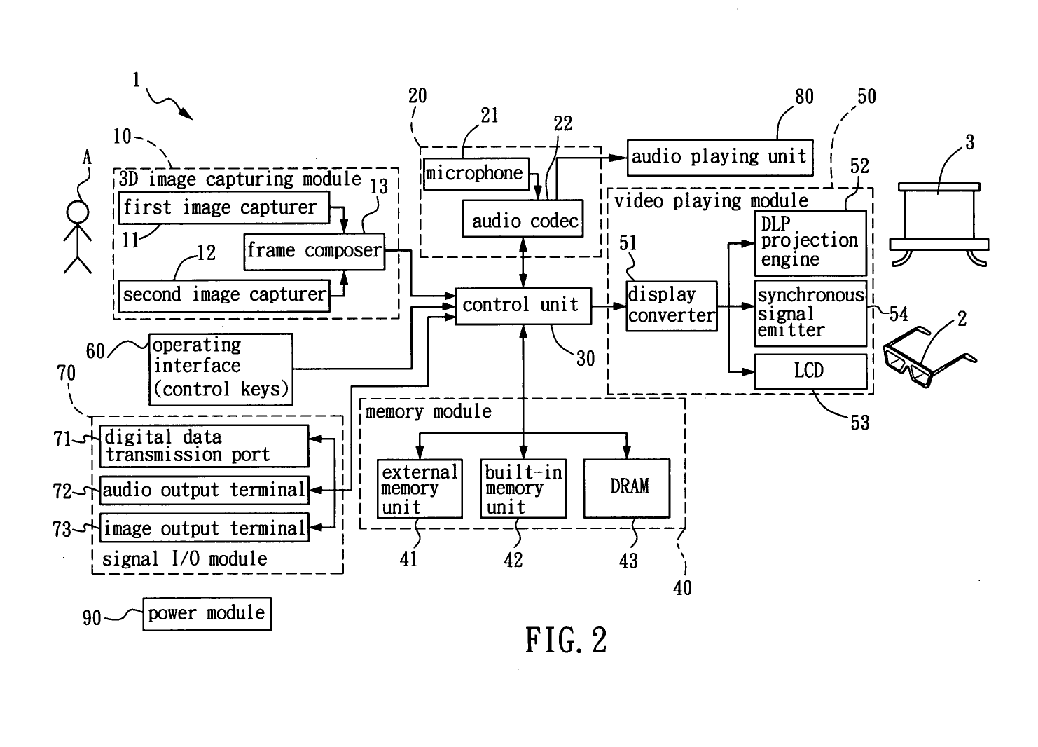

Refer to FIG. 1 and FIG. 2 for a schematic view and a circuit block diagram, respectively, of a 3D image capturing and playing device in a preferred embodiment of the present invention. As shown in the drawings, a 3D image capturing and playing device 1 includes a 3D image capturing module 10, an audio capturing module 20, a control unit 30, a memory module 40, a video playing module 50, an operating interface 60, a signal I/O module 70, an audio playing unit 80, and a power module 90. The power module 90 supplies power to all the elements of the 3D image capturing and playing device 1 of the present invention and at least includes one of a battery and a power supply connectable to an external power source.

The 3D image capturing module 10 captures a static or dynamic image of an external object A from the outside and converts the image into a digital image signal. In this embodiment, the 3D image capturing module 10 includes a first image capturer 11, a second image capturer 12, and a frame composer 13. The first image capturer 11 captures a first image from the outside and converts the first image into a plurality of first image frame signals. Likewise, the second image capturer 12 captures a second image from the outside and converts the second image into a plurality of second image frame signals. The first image capturer 11 and the second image capturer 12 are horizontally spaced apart from each other by a predetermined distance, such as but not limited to the normal distance (about 6-45 cm) between the eyes of a human being. Hence, the images captured by the first and second image capturers 11, 12 are used to simulate the images of the external object A as watched with the left and right eyes of a human being. The frame composer 13 is coupled between the first image capturer 11, the second image capturer 12, and the control unit 30 and is configured for receiving the first image frame signals and/or the second image frame signals and generating the digital image signal accordingly.

In an embodiment of the present invention, the 3D image capturing module 10 is controlled by the control unit 30 to operate in a 3D image capturing mode or a 2D image capturing mode. In addition, the first and second image capturers 11, 12 each include a lens set (not shown) and an image sensor (not shown). The lens set is a zoom lens. The image sensor preferably includes a CCD or a CMOS image sensing chip.

Where the 3D image capturing module 10 operates in the 3D image capturing mode, both the first and second image capturers 11, 12 are operating, and the frame composer 13 receives the first and second image frame signals from the first and second image capturers 11, 12, respectively, and composes the digital image signal in such a manner that the first image frame signals alternate with the second image frame signals. In other words, the digital image signal is composed of, in sequence, a first image frame signal, a second image frame signal, another first image frame signal, another second image frame signal, and so forth, in which the first image frame signals alternate with the second image frame signals.

The aforesaid embodiment where the digital image signal is composed of the alternating first and second image frame signals is applicable to capturing 3D dynamic images of the external object A. In this embodiment, if a 3D static image is captured, the digital image signal only includes one first image frame signal and one second image frame signal.

Where the 3D image capturing module 10 operates in the 2D image capturing mode to capture dynamic images, only one of the first and second image capturers 11, 12 (for example, only the first image capturer 11) operates; meanwhile, the frame composer 13 receives the first image frame signals from the first image capturer 11 only, and composes the digital image signal with the first image frame signals thus received. It is to be understood that if a static image is captured, the digital image signal includes one first image frame signal only.

The audio capturing module 20 captures a sound from the outside and converts the sound into a digital audio signal. In this embodiment, the audio capturing module 20 includes a microphone (Mic) 21 for capturing a sound from the outside and an audio codec 22 coupled between the Mic 21 and the control unit 30. The audio codec 22 converts the sound captured by the Mic 21 into the digital audio signal and converts the digital audio signal transmitted from the control unit 30 into a sound to be played by the audio playing unit 80 (e.g., a loudspeaker) externally.

The control unit 30 is coupled to the 3D image capturing module 10 and the audio capturing module 20 to control the operation of the 3D image capturing module 10 and the audio capturing module 20. Also, the control unit 30 receives the digital image signal and the digital audio signal and combines them into computer-readable digital video data. In an embodiment of the present invention, the control unit 30 includes a digital signal processor (DSP).

The memory module 40 is coupled to the control unit 30 and controlled by the control unit 30 to store the digital video data or allow the digital video data stored in advance to be read, processed, and divided into the digital image signal and the digital audio signal to be played by the video playing module 50 and the audio playing unit 80, respectively. In this embodiment, the memory module 40 includes at least one of an external memory unit 41, a built-in memory unit 42, and a dynamic random access memory (DRAM) 43. The external memory unit 41 includes a card reader for receiving and accessing data stored in a memory card 5 provided externally. The built-in memory unit 42 includes at least one of a hard disk drive and a flash memory.

The video playing module 50 is coupled to the control unit 30 and is controlled thereby to play externally the digital image signal derived from processing the digital video data. In this embodiment, the video playing module 50 includes a display converter 51, a DLP projection engine 52, a liquid crystal display (LCD) 53, and a synchronous signal emitter 54. The display converter 51 receives from the control unit 30 an image playing control signal and the digital image signal derived from the digital video data. According to the image playing control signal transmitted from the control unit 30, the display converter 51 determines whether the digital image signal of the digital video data should be converted into a 3D image playing signal or a 2D image playing signal and whether the 3D or 2D image playing signal should be sent to the DLP projection engine 52 or the LCD 53 or both, for playing. When the DLP projection engine 52 or the LCD 53 plays the 3D image playing signal (i.e., a 3D dynamic image), the synchronous signal emitter 54 emits a synchronous control signal corresponding to the 3D image playing signal.

In this embodiment, the synchronous signal emitter 54 emits a synchronous signal by a wireless means, and the synchronous signal emitter 54 is, but not limited to, one of the following: an IR transmitter, a Bluetooth dongle, and a wireless dongle. The DLP projection engine 52 includes elements required for implementing optical projection such as, but not limited to, a light source (not shown), a digital micromirror device (DMD) (not shown), a projection lens (not shown), and a heat dissipating unit (not shown). The DLP projection engine 52 projects a 2D or 3D image onto an externally provided screen 3 so as for users to view the image. In an embodiment of the present invention, the LCD 53 is a parallax barrier screen switchable between a 3D display mode and a 2D display mode, thereby allowing a user to view, with the naked eye, the 3D dynamic image played by the LCD 53. In another embodiment, the LCD 53 is a conventional LCD screen, and the user has to wear a pair of 3D shutter glasses 2 which, coupled with the synchronous signal emitted from the synchronous signal emitter 54, allow the user to view the 3D dynamic image played by the LCD 53.

The operating interface 60 is coupled to the control unit 30 and includes a plurality of control keys or a control dial whereby the 3D image capturing and playing device 1 of the present invention is operated and controlled.

The signal I/O module 70 is coupled to the control unit 30 and includes a digital data transmission port 71, an audio output terminal 72, and an image output terminal 73 which are respectively connectable to an external electronic device to transmit the digital video data, the digital audio signal, and the 3D or 2D image playing signal. In an embodiment of the present invention, the digital data transmission port 71 is a socket conforming to one of a USB standard, a mini-USB standard, and an IEEE 1394 standard. The digital data transmission port 71 is connectable to an external device 4 having the same communication interface such as, but not limited to, an external hard disk drive, an external card reader, or an external CD-ROM. Through the digital data transmission port 71, the control unit 30 writes or reads the digital video data into or from the external device 4 connected to the digital data transmission port 71.

Different aspects of implementation of 3D or 2D image capturing or playing by the 3D image capturing and playing device of the present invention are described hereinafter by way of specific examples.

### Example 1

When the 3D image capturing module 10 is operating in the 2D image capturing mode, the first image capturer 11 captures an image of the external object A at a first frequency and generates a plurality of first image frame signals accordingly. (For instance but without limitation, the first image frame signals are generated at a frequency of 30 or 60 image frames per second, i.e., 30 fps or 60 fps.) Meanwhile, the frame composer 13 composes the digital image signal also at the first frequency.

### Example 2

When the 3D image capturing module 10 is operating in the 3D image capturing mode, the first image capturer 11 and the second image capturer 12 generate a plurality of first image frame signals and a plurality of second image frame signals at a second frequency, respectively, wherein the second frequency is half of the first frequency. (For instance but without limitation, the first frequency is 30 fps while the second frequency is 15 fps.) On the other hand, the frame composer 13 composes the digital image signal at the first frequency.

### Example 3

When the 3D image capturing module 10 is operating in the 3D image capturing mode, the first image capturer 11 and the second image capturer 12 generate a plurality of first image frame signals and a plurality of second image frame signals at the first frequency, respectively; however, the frame composer 13 captures the first image frame signals and the second image frame signals at the second frequency, respectively, wherein the second frequency is half of the first frequency. (For instance but without limitation, the first frequency is 30 fps while the second frequency is 15 fps.) Furthermore, the frame composer 13 composes the digital image signal at the first frequency. In other words, in the embodiment of Example 3, half of the image frame signals generated by the first and second image capturers 11, 12 are discarded.

### Example 4

When the 3D image capturing module 10 is operating in the 3D image capturing mode, the first image capturer 11 and the second image capturer 12 generate a plurality of first image frame signals and a plurality of second image frame signals at the first frequency, respectively, and the frame composer 13 captures the first image frame signals and the second image frame signals also at the first frequency, respectively. Moreover, the frame composer 13 composes the digital image signal at a third frequency which is two times the first frequency. (For instance but without limitation, the first frequency is 30 fps, and the third frequency is 60 fps.)

### Example 5

When the digital video data are generated in the 3D image capturing mode, and when the display converter 51 determines to convert the digital video data into the 3D image playing signal according to the image playing control signal, the display converter 51 sends, at a multiplied speed and by alternation, the first and second image frame signals to the DLP projection engine 52 and/or the LCD 53 (switched to the 3D display mode) for playing. Meanwhile, the display converter 51 controllably instructs the synchronous signal emitter 54 to emit a synchronous control signal synchronized with the alternating first and second image frame signals. The synchronous control signal is received by the externally provided 3D shutter glasses 2, which in turn switch the views of the left and right eyes according to the synchronous control signal and thereby effectuate 3D imaging. More specifically, while the DLP projection engine 52 (or the LCD 53) is playing an image of the first image frame signals, the 3D shutter glasses 2 open the left-eye view but shut the right-eye view (i.e., allowing light to fall on the left eye but not on the right eye) according to the synchronous control signal received, and in consequence the user can see the image of the first image frame signals with the left eye only. By contrast, while the DLP projection engine 52 (or the LCD 53) is playing an image of the second image frame signals, the 3D shutter glasses 2 open the right-eye view but shut the left-eye view according to the synchronous control signal received, and in consequence the user can see the image of the second image frame signals with the right eye only In so doing, the 3D image capturing and playing device 1 produces a visual effect of simulated 3D images.

### Example 6

When the digital video data are generated in the 3D image capturing mode, and when the display converter 51 determines to convert the digital video data into the 2D image playing signal according to the image playing control signal, the display converter 51 merely sends the first image frame signals to the DLP projection engine 52 and/or the LCD 53 (switched to the 2D display mode) for playing; meanwhile, the synchronous signal emitter 54 is not operating. Thus, the user can watch 2D images with the naked eye or with the 3D shutter glasses 2.

### Example 7

When the digital video data are generated in the 2D image capturing mode, the display converter 51 only converts the digital video data into the 2D image playing signal to be played by the DLP projection engine 52 and/or the LCD 53 functioning in the 2D display mode; meanwhile, the synchronous signal emitter 54 is not operating. Thus, the user can watch 2D images only.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A 3D image capturing and playing device, comprising:
a 3D image capturing module for capturing an image from an outside and converting the image into a digital image signal;
an audio capturing module for capturing a sound from the outside and converting the sound into a digital audio signal;
a control unit coupled to the 3D image capturing module and the audio capturing module and configured for control thereof and for receiving and combining the digital image signal and the digital audio signal into computer-readable digital video data;
a memory module coupled to the control unit and controlled thereby to store the digital video data or allow the digital video data stored in advance to be read;
a video playing module coupled to the control unit and controlled thereby to play the digital video data externally, wherein the video playing module comprises a display converter, a DLP projection engine, a liquid crystal display (LCD), and a synchronous signal emitter; and
a power module for supplying power to the 3D image capturing and playing device,
wherein the display converter receives an image playing control signal and the digital video data from the control unit and, according to the image playing control signal transmitted from the control unit, determines whether to convert the digital video data into a 3D image playing signal or a 2D image playing signal and whether to send the 3D image playing signal or the 2D image playing signal to the DLP projection engine, the LCD, or both the DLP projection engine and the LCD for playing;
wherein the synchronous signal emitter emits a synchronous control signal corresponding to the 3D image playing signal while the DLP projection engine or the LCD is playing the 3D image playing signal.

2. The 3D image capturing and playing device of claim 1, wherein the 3D image capturing module comprises:
a first image capturer for capturing a first image from the outside and generating a plurality of first image frame signals accordingly;
a second image capturer for capturing a second image from the outside and generating a plurality of second image frame signals accordingly, the second image capturer being horizontally spaced apart from the first image capturer by a predetermined distance; and
a frame composer coupled between the first image capturer, the second image capturer, and the control unit and configured for receiving the first image frame signals and/or the second image frame signals and generating the digital image signal accordingly,
wherein the 3D image capturing module is controlled by the control unit to operate in one of a 3D image capturing mode and a 2D image capturing mode;
wherein, with the 3D image capturing module operating in the 3D image capturing mode, the frame composer receives the first and second image frame signals from the first and second image capturers, respectively, and composes the digital image signal in such a manner that the first image frame signals alternate with the second image frame signals;
wherein, with the 3D image capturing module operating in the 2D image capturing mode, the frame composer only receives the first image frame signals from the first image capturer and composes the digital image signal accordingly.

3. The 3D image capturing and playing device of claim 2, wherein, with the 3D image capturing module operating in the 2D image capturing mode, the first image capturer generates the first image frame signals at a first frequency, and the frame composer composes the digital image signal at the first frequency.

4. The 3D image capturing and playing device of claim 3, wherein, with the 3D image capturing module operating in the 3D image capturing mode, the first image capturer and the second image capturer generate the first image frame signals and the second image frame signals at a second frequency, respectively, the second frequency being half of the first frequency, and the frame composer composes the digital image signal at the first frequency.

5. The 3D image capturing and playing device of claim 3, wherein, with the 3D image capturing module operating in the 3D image capturing mode, the first image capturer and the second image capturer generate the first image frame signals and the second image frame signals at the first frequency, respectively, and the frame composer captures the first image frame signals and the second image frame signals at the second frequency, respectively, and composes the digital image signal at the first frequency, the second frequency being half of the first frequency.

6. The 3D image capturing and playing device of claim 3, wherein, with the 3D image capturing module operating in the 3D image capturing mode, the first image capturer and the second image capturer generate the first image frame signals and the second image frame signals at the first frequency, respectively, and the frame composer captures the first image frame signals and the second image frame signals at the first frequency, respectively, and composes the digital image signal at a third frequency, the third frequency being two times the first frequency.

7. The 3D image capturing and playing device of claim 1, further comprising an audio playing unit, wherein the audio capturing module comprises a microphone (Mic) for capturing the sound from the outside, and an audio codec coupled between the Mic and the control unit, the audio codec not only converting the sound captured by the Mic into the digital audio signal but also converting the digital audio signal transmitted from the control unit into another sound to be played by the audio playing unit externally.

8. The 3D image capturing and playing device of claim 2, wherein the LCD is a parallax barrier screen switchable between a 3D display mode and a 2D display mode;
wherein, with the digital video data being generated in the 3D image capturing mode and with the display converter determining to convert the digital video data into the 3D image playing signal according to the image playing control signal, the display converter not only sends, at a multiplied speed and by alternation, the first and second image frame signals to the DLP projection engine and/or the LCD in the 3D display mode, but also controllably instructs the synchronous signal emitter to emit the synchronous control signal synchronized with the alternating first and second image frame signals, the synchronous control signal being received by externally provided 3D shutter glasses such that the 3D shutter glasses switch left- and right-eye views according to the synchronous control signal received and thus effectuate 3D imaging;
wherein, with the digital video data being generated in the 3D image capturing mode and with the display converter determining to convert the digital video data into the 2D image playing signal according to the image playing control signal, the display converter only sends the first image frame signals to the DLP projection engine and/or the LCD in the 2D display mode, and the synchronous signal emitter is not operating;
wherein, with the digital video data being generated in the 2D image capturing mode, the display converter only converts the digital video data into the 2D image playing signal to be played by the DLP projection engine and/or the LCD in the 2D display mode, and the synchronous signal emitter is not operating.

9. The 3D image capturing and playing device of claim 2, further comprising:
an operating interface coupled to the control unit and comprising a plurality of control keys by which the 3D image capturing and playing device is operated and controlled; and
a signal I/O module coupled to the control unit and comprising a digital data transmission port, an audio output terminal, and an image output terminal respectively connectable to an external electronic device to thereby transmit the digital video data, the digital audio signal, and the 3D or 2D image playing signal.

10. The 3D image capturing and playing device of claim 9, wherein the digital data transmission port conforms to one of a USB standard, a mini-USB standard, and an IEEE 1394 standard, and the memory module comprises at least one of an external memory unit, a built-in memory unit, and a dynamic random access memory (DRAM), the external memory unit comprising a card reader for receiving and accessing data stored in an externally provided memory card, and the built-in memory unit comprising at least one of a hard disk drive and a flash memory.
